(19) United States
(12) Patent Application Publication
(10) Pub. No.: US 2012/0082868 A1
(43) Pub. Date: Apr. 5, 2012

(54) Floating Microbial Fuel Cells

(75) Inventors: Yuelong Huang, Gainesville, FL (US); Zhen He, Bayside, WI (US); Florian Mansfeld, Los Angeles, CA (US)

(73) Assignee: UNIVERSITY OF SOUTHERN CALIFORNIA, Los Angeles, CA (US)

(21) Appl. No.: 13/250,939

(22) Filed: Sep. 30, 2011

Related U.S. Application Data
(60) Provisional application No. 61/389,104, filed on Oct. 1, 2010.

(51) Int. Cl. H01M 8/16; H01M 4/92; H01M 4/96

(52) U.S. Cl. 429/2; 429/400

(57) ABSTRACT

A microbial fuel cell (MFC) includes a cation exchange membrane defining an anode chamber, an anode positioned in the anode chamber, and a cathode in contact with an exterior of the cation exchange membrane. A restrictor in contact with the cation exchange membrane defines an opening through which water flows into or out of the anode chamber. The MFC includes bacteria in the anode chamber that oxidize organic compounds in the water while oxygen is reduced at the cathode, such that electricity is generated in the absence of an external power source. In an example, the MFC is coupled to a buoy and provides electricity to an electrically powered device also coupled to the buoy, thereby providing a low-maintenance source of power in remote locations. The electrically powered device may be, for example, a light or a sensor.

### CROSS-REFERENCE TO RELATED APPLICATION

This application claims priority to U.S. Application Ser. No. 61/389,104, filed on Oct. 1, 2010, which is incorporated by reference herein.

### TECHNICAL FIELD

This invention relates to floating microbial fuel cells.

### BACKGROUND

Electrical energy can be harvested using sediment microbial fuel cells (SMFCs) that include an anode embedded in marine or river sediment and a cathode suspended in the aerobic water column above the anode. Bacteria inhabiting the sediment oxidize organic compounds and supply electrons to the anode while oxygen is reduced at the cathode. Among the different electrochemically active bacteria, Desulfuromonace spp. have been shown to be rich in marine sediments, while Geobacter spp. seem to predominate in freshwater sediments.

Electric power is typically provided to remote sensors or other electronic devices near large bodies of water via batteries. In some cases, the cost to replace the batteries may exceed the cost of the batteries themselves. SMFCs have been studied and developed to operate low-power consuming electronic devices installed in marine and river environments. While SMFCs may provide some advantages over current technologies, such as batteries, because of low cost and less frequent maintenance, the cathode is generally deployed close to the water surface to ensure sufficient oxygen supply, and the maximum distance between the anode and the cathode can be limited due at least in part to increased installation difficulties and ohmic drop. Thus, SMFCs may not be suitable in deep water at remote locations.

### SUMMARY

In a first general aspect, a microbial fuel cell includes a cation exchange membrane defining an anode chamber, an anode positioned in the anode chamber, and a cathode in contact with an exterior of the cation exchange membrane. A restrictor in contact with the cation exchange membrane and defines an opening through which water flows into or out of the anode chamber.

In a second general aspect, an apparatus includes a buoy coupled to a microbial fuel cell as described by the first general aspect. In some cases, the apparatus includes an electrically powered device, and the microbial fuel cell is electrically coupled to the electrically powered device such that the microbial fuel cell provides electricity to the electrically powered device.

A third general aspect includes positioning a buoy comprising an electrically powered device and a microbial fuel cell in a body of water, and powering the electrically powered device with electricity generated by the microbial fuel cell.

Implementations of the above aspects may independently include one or more of the following features. For example, in some cases, the microbial fuel cell is cylindrical in shape. The cation exchange membrane can be tubular. The anode chamber defines a volume of at least 1 L, at least 2 L, at least 5 L, or at least 10 L. The anode may include carbon, such as granular carbon. The granular carbon may have a size in the range of 3 mm to 10 mm. In some cases, a size of the granular carbon is on the order of microns (e.g., 1 μm to 1000 μm). The size of the granular carbon can be selected to increase a surface-to-volume ratio of the anode while maintaining adequate mass transfer using the packed bed electrode principle. The anode may also include a conductive current collector made, for example, of titanium. The anode chamber includes bacteria (e.g., a mixture of aerobic and anaerobic bacteria) for oxidizing organic compounds.

The cathode of the microbial fuel cell includes a conductive material and a catalyst to facilitate reduction of oxygen at the cathode. In an example, the catalyst includes platinum. The conductive material and the catalyst are supported by an exterior surface of the cation exchange membrane, and an interior surface of the cation exchange membrane defines the anode chamber. In some cases, the catalyst is supported by the exterior surface of the cation exchange membrane, and the conductive material forms a layer on the catalyst. An additional layer of catalyst may be formed on the conductive material. The conductive material may include, for example, carbon fibers. In some cases, the carbon fibers have a metal coating.

In some implementations, the microbial fuel cell includes a second restrictor in contact with the cation exchange membrane, the second restrictor defining a second opening through which water flows into or out of the anode chamber.

The microbial fuel cell is operable to generate electricity in the absence of an external power source. The electrically powered device may be, for example, a light or a sensor. Electricity generated by the microbial fuel cell is used to power the electrically powered device.

The microbial fuel cell is a low-cost, low-maintenance source of continuous electricity for electrically powered devices in remote locations and/or deep water settings.

### BRIEF DESCRIPTION OF THE DRAWINGS

FIG. 1A is a schematic diagram of an example of a floating microbial fuel cell (FMFC).

FIG. 1B depicts a FMFC coupled to a buoy.

FIG. 2 is a plot of current vs. time for a FMFC from day 129 to day 139 of operation.

FIG. 3 is a plot of average current vs. operating time for a FMFC.

FIG. 4 shows cell voltage-current curves for different operating times of a FMFC.

FIG. 5 shows power and power concentration-cell voltage curves for different operating times of a FMFC.

FIG. 6 is a plot of Pₘₐₓ vs. operating time for a FMFC.

FIG. 7 shows internal resistance and slope of the voltage-current curves shown in FIG. 4 as a function of operating time.

FIG. 8 shows a comparison of measured and calculated power-cell voltage curves for a FMFC with an operating time of 153 days.

FIG. 9 shows Bode plots for the anode of a FMFC for different operating times.

FIG. 10 shows Bode plots for the cathode of a FMFC for different operating times.

FIG. 11 shows a digital recording of seawater temperature at a FMFC test location.

FIG. 12A shows denaturing gradient gel electrophoresis (DGGE) fingerprints of bacterial communities (anode and mixed innoculums).

FIG. 12B shows a phylogenetic analysis of DGGE band sequences shown in FIG. 12A.

### DETAILED DESCRIPTION

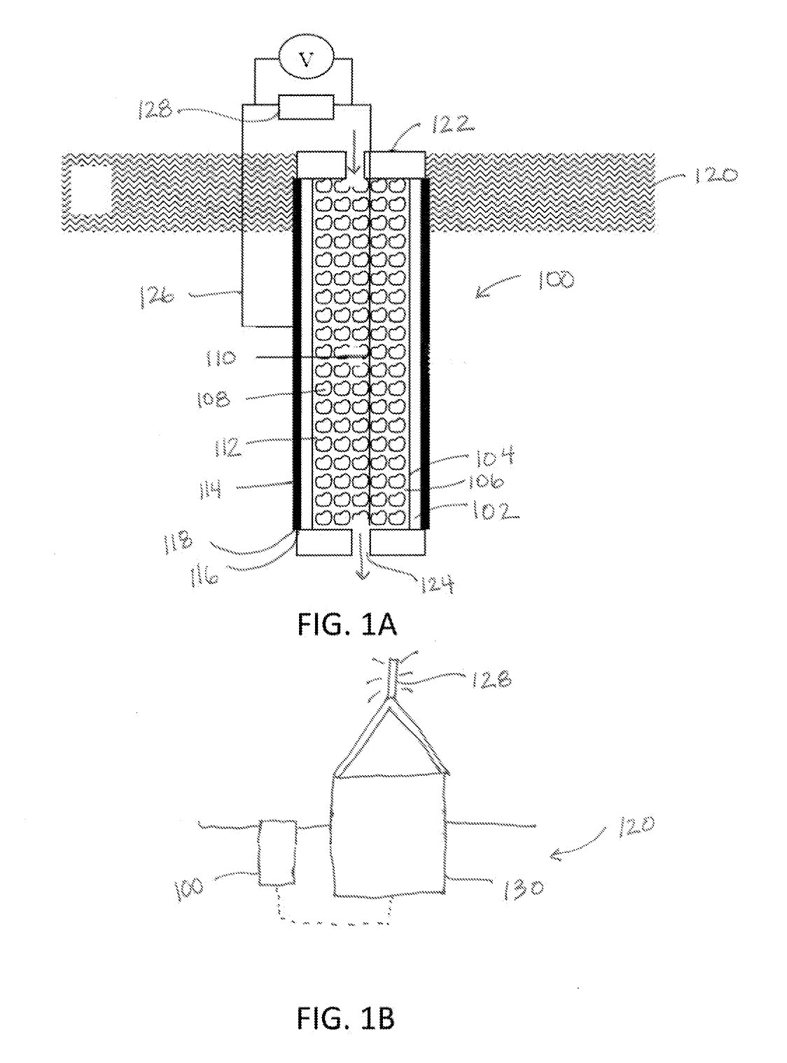

Referring to FIG. 1A, floating microbial fuel cell (FMFC) 100 includes cation exchange membrane 102. Cation exchange membrane 102 defines anode chamber 104. A shape of FMFC 100 or a shape of cation exchange membrane 102 may be, for example, cylindrical (e.g., tubular), spherical, cubic, or any other shape configured to define anode chamber 104. A volume of anode chamber 104 may be at least 1 L, at least 2 L, at least 5 L, or at least 10 L. In some cases, FMFC 100 includes more than one anode chamber (e.g., 2, 4, 6, 8, 10, or more).

Anode 106 in anode chamber 104 includes anode material 108 and current collector(s) 110. Anode material 108 includes, for example, granular carbon. A size of the granular carbon may be in a range of 3 mm to 10 mm, or on micron scale (e.g., 1 μm to 1000 μm). The power output of FMFC can be increased by increasing the surface-to-volume ratio of the anode while maintaining adequate mass transfer using the packed bed electrode principle.

Current collector(s) 110 may include conductive members, such as wires or rods formed from titanium, gold, or the like. The anode chamber may be inoculated with bacteria 112. Bacteria 112 may be provided to anode chamber 104 in the form of anaerobic sludge, aerobic sludge, or a mixture thereof. The sludge may be obtained from a wastewater treatment plant or may include sediment from a body of water, such as a river, lake or ocean. The sludge includes a mixture of electrochemically active aerobic and anaerobic bacteria that oxidize organic compounds in the water inside anode chamber 104 and supply electrons to the anode. Examples of suitable bacteria include Beta and Gammaproteobacteria.

Cathode 114 is supported by cation exchange membrane 102. Cathode 114 includes catalyst 116 and conductive material 118. The catalyst facilitates reduction of oxygen at the cathode. In some cases, catalyst 116 and conductive material 118 are applied in layers to cathode 114 (e.g., a first layer of catalyst, a conductive material, a second layer of catalyst). In other cases, a mixture of catalyst 116 and conductive material 118 is applied to the exterior surface of cation exchange membrane 102. Catalyst 116 may include, for example, platinum or other catalysts used to facilitate reduction of oxygen in the water. Conductive material 118 may include carbon fibers, carbon nanotubes, carbon nanowires, carbon nanoparticles, or the like. In some cases, conductive material 118 is coated with a metal, such as nickel or the like.

In some cases, FMFC 100 has an associated buoyancy that causes FMFC 100 to float in water 120. Buoyancy may be associated with anode chamber 104, for example, in a gas-filled compartment. In certain cases, buoyancy is provided by a ballast system or buoy coupled to FMFC 100. In an example, FMFC may be installed in a buoy flowing on water 120. Water 120 may be part of a lake, river or ocean. FMFC 100 includes one or more restrictors 122. Restrictor(s) 122 may be in contact with cation exchange membrane 102. Each restrictor 122 defines one or more openings 124 through which water 120 flows into or out of anode chamber. The arrows in FIG. 1A indicate a flow of water into anode chamber 104 through a first opening 124 and out of the anode chamber through a second opening. The area of openings 124 may be selected to allow sufficient circulation of water through the anode chamber while inhibiting excessive oxygen flux into the anode chamber.

Anode 106 is electrically coupled to cathode 114 via conductor 126. FMFC 100 may be used to provide electricity to low-power consuming electronic devices at remote locations (e.g., deep marine locations). In some cases, FMFC 100 is electrically coupled to electrically powered device 128. Electrically powered device 128 may be, for example, a component of a buoy. The component may be, for example, a light or a sensor. FMFC 100 generates electricity in the absence of an external power source when placed in body of water 120. The generated electricity may be continuous, and may be used to power electrically powered device 128. Thus, FMFC 100 may be used as low-cost, low-maintenance alternative to batteries proximate bodies of water.

FIG. 1B shows FMFC 100 coupled to buoy 130 in water 120. FMFC 100 can be secured to buoy 130. In some cases, FMFC 100 is electrically coupled to electrically powered device 128 and provides a low-cost, low maintenance, continuous source of electricity for the electrically powered device. FMFC 100 can be advantageously used in remote locations and/or deep water settings, with all components of the FMFC located together at and accessible from the surface of the water. Other configurations are also possible, including integrating FMFC 100 with buoy 130 at the time of manufacture.

### EXAMPLES

A single-chamber tubular FMFC was designed, and its performance was evaluated for 153 days using different electrochemical techniques. The FMFC was allowed to float at the ocean surface hanging from a cable attached to a dock at Long Beach Harbor, Calif. Over the period of operation of the FMFC, the cell current and the power output gradually increased to maximum values at 125 days and then decreased. A linear relationship between cell voltage (V) and current (I) was observed. The slopes of the V-I curves were close to the experimental values of the internal resistance (Rᵢₙₜ) that were obtained from the power (P)-V curves or from analysis of the impedance data. The maximum current (Iₘₐₓ), the P-V curves and maximum power output (Pₘₐₓ) were calculated based on the experimental values of the open-circuit cell voltage (Vₒ) and Rᵢₙₜ. Impedance spectra were collected at the open-circuit potentials of the anode and cathode. The polarization resistance of the anode (Rₐₚ) changed with operating time, reaching a minimum value at 125 days, while the polarization resistance of the cathode (R_{cp}) was relatively constant and smaller than Rₐₚ. Results suggest that electricity was constantly produced by the FMFC, and that the observed changes of Rᵢₙₜ and Pₘₐₓ with exposure time were due at least in part to the changes of Rₐₚ. PCR-DGGE analysis of microbial communities showed the development of unique bacterial species on the anode during operation.

The FMFC described in this example was constructed using a tube made of cation exchange membrane (Ultrex CMI7000, Membranes International, USA). The tube had a diameter of 9 cm and a length of 70 cm with a total anode volume of 4.5 L. The top and bottom of the tube were covered with rubber stoppers. Each rubber stopper had a small hole with a diameter of 8 mm to allow circulation of ocean water through the FMFC while inhibiting excessive oxygen flux into the anode chamber. Granular graphite (diameter about 10 mm, Carbon Activated Corp, Compton, Calif., USA) was used to fill the tube and to function as the anode, resulting in an anode liquid volume of 2.3 L. Three titanium wires were inserted into the granular graphite as current collectors.

Before being deployed in the ocean, the FMFC was operated in the laboratory to examine its electricity generation from organic compounds. It was fed continuously with a solution containing: NaC₂H₃O₂.3H₂O (3 g/L); yeast extract (0.2 g/L); NH₄Cl (1 g/L); MgSO₄ (0.25 g/L); NaCl (0.5 g/L); CaCl₂ (15 mg/L); trace solution (1 mL/L) (He et al., Spectroscopy. Environ. Sci. Technol., 40, 5212-5217, which is incorporated by reference herein.), and phosphate buffered nutrient medium (100 mL/L) containing NaH₂PO₄ (50 g/L) and Na₂HPO₄ (107 g/L). Forty mL of a mixture of anaerobic and aerobic sludge (50/50) that was collected from a wastewater treatment plant (Joint Water Pollution Plant, CA) were injected into the anode chamber as inoculum.

The cathode included Ni-coated carbon fibers (TenaX®-J, Toho Tenax Co., Ltd., grade HTS 40, Irvine, Calif., USA) and two catalyst layers. To make a catalyst layer, powder of Pt/C (10% Pt, Etek, Somerset, N.J., USA) was mixed with tap water to form a paste that was applied to the outer surface of the membrane tube using a brush. This layer was then covered by carbon fibers. The second catalyst layer (same composition as the first catalyst layer, but mixed with a Nafion solution) was applied to the outside of the carbon fibers. The catalysts layers were air dried for 48 hours at room temperature before operation.

Before deployment of the FMFC, the feeding had been stopped for a few days to allow the voltage to drop to very low levels (<10 mV). In addition, to facilitate the transport of the FMFC from the lab to the test site, the solution inside the FMFC was decanted. That also reduced the chance of electricity generation from the remaining organics (if any) during the deployment in the sea. After the laboratory examination and operation, the tubular MFC was installed hanging from a cable that was attached to a dock at the seawater surface at Long Beach Harbor, Calif. for 153 days during which time electrochemical measurements were performed.

The voltage across an external resistor (Rₑₓₜ) of 100 ohm was recorded every 4 minutes for 153 days using a data logging multimeter. Cell voltage (V)-current curves (I) were recorded by applying a potentiodynamic scan at a scan rate of 0.2 mV/s from the open-circuit cell voltage (Vₒ) to the short-circuit cell voltage (V_{sc}). During this measurement, the anode of the FMFC was connected to the working electrode lead and the cathode was connected to the counter and reference electrode leads of the potentiostat. Impedance spectra were collected at the open-circuit potentials (OCP) of the anode and cathode. An AC voltage signal of 10 mV was applied in a frequency range from 100 kHz to 5 mHz. A saturated calomel electrode (SCE) placed in the seawater next to the FMFC was used as the reference electrode. Electrochemical impedance spectroscopy (EIS) measurements were conducted by first recording the impedance spectrum of the anode with the cathode acting as counter electrode (CE) followed by recording of the spectra for the cathode with the anode serving as CE. These electrochemical measurements were performed in the seawater at Long Beach Harbor, Calif. using a Gamry reference 600 potentiostat (Garmry Instruments, Warminster, Pa., USA).

Genomic DNA was extracted using an ULTRACLEAN™ Soil DNA kit (MO BIO Laboratories, Carlsbad, Calif.) from mixed inoculums and graphite beads in the anode electrode following the manufacturer's instructions. Polymerase chain reaction (PCR) and denaturing gradient gel electrophoresis (DGGE) analyses were performed as previously described (He et al., Environ. Sci. Technol., 43 (2009): 3391-3397 and Kan et al., Aquat. Microb. Ecol., 42 (2006): 7-18, both of which are incorporated by reference herein) by using the primers 1070f and 1392r (Ferris et al., Appl. Environ. Microbiol., 62 (1996): 340-346, which is incorporated by reference herein).

Representative bands excised from DGGE gel were re-amplified and PCR products were purified by ExoSAP-IT (USB, Cleveland, Ohio) and sequenced with primer 1070f by using Bigdye terminator chemistry by ABI PRISM3100 Genetic Analyzer (Applied Biosystems, Foster City, Calif.). All sequences were compared with GenBank database using BLAST, and the closest matched sequences were obtained and included in the phylogeny reconstruction (He et al., 2009 and Kan et al., 2006). Nanoarchaeum equitans was used as an outgroup. Bootstrap values were calculated based on 1000 resampling datasets. For clarity, only bootstrap values relevant to the interpretation of groupings were shown. The scale bar indicates the number of substitutions per site. DGGE band sequences have been deposited in the GenBank database under accession numbers GU938704-GU938713.

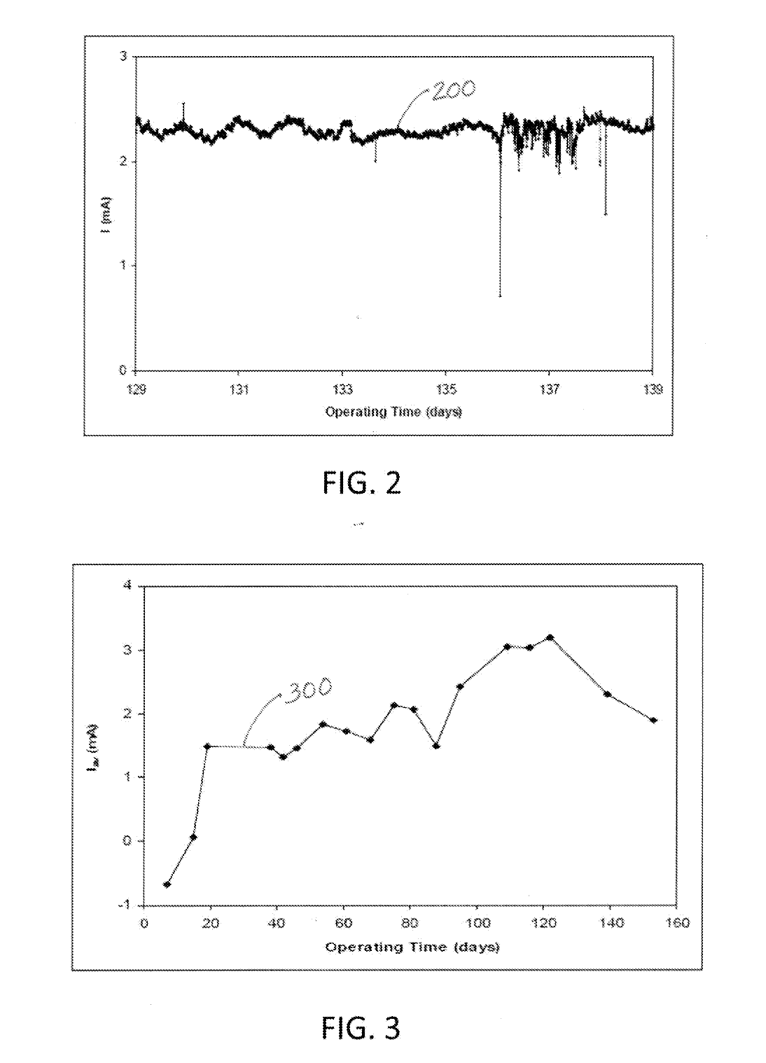

The performance of the FMFC was investigated using different electrochemical techniques. An example of the recorded current-time curves 200 is shown in FIG. 2 for the operating period between 129 and 139 days. The cell current had an average value of 2.35 mA and remained relatively constant during these ten days of operation. FIG. 3 shows plot 300 of average cell currents as a function of operation time. Each current point plot 300 was obtained as the average value for an operating time of 3 to 10 days. The current increased to 1.5 mA during the first 20 days of operation, indicating a transformation of lab freshwater MFC to a seawater MFC. During next 70 days, the current varied between 1.5 and 2.2 mA. Another increase of the current to 3.3 mA occurred until 125 days followed by a decrease of the current. At the end of exposure the current had decreased to 1.9 mA.

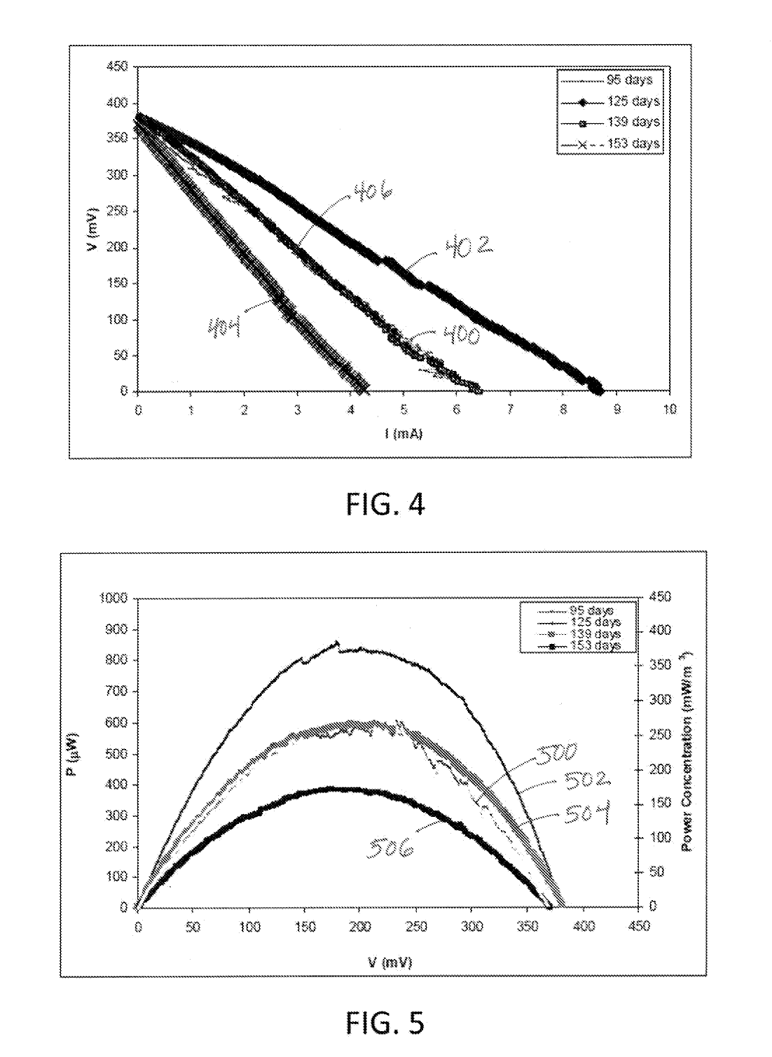

The V-I and P-V curves obtained at four different operating periods are shown in FIG. 4 and FIG. 5, respectively. The open-circuit cell voltage (Vₒ) for the entire operating period was about 380 mV. This low Vₒ may be due to the presence of dissolved oxygen in the anode compartment as indicated by a high anode potential (between −54 to −15 mV vs. SCE). FIG. 4 shows plots 400, 402, 404, and 406 corresponding to operating times of 95 days, 125 days, 139 days, and 153 days, respectively. The highest short-circuit current of 8.7 mA occurred at 125 days and the lowest of 4.2 mA was at 153 days of operation.

FIG. 5 shows the values of the power and the power concentration P*=P/Vₐ (where Vₐ is the anode liquid volume), which were calculated from the measured V-I curves shown in FIG. 4 as a function of the cell voltage. Plots 500, 502, 504, and 506 correspond to an operating time of 95 days, 125 days, 139 days, and 153 days, respectively.

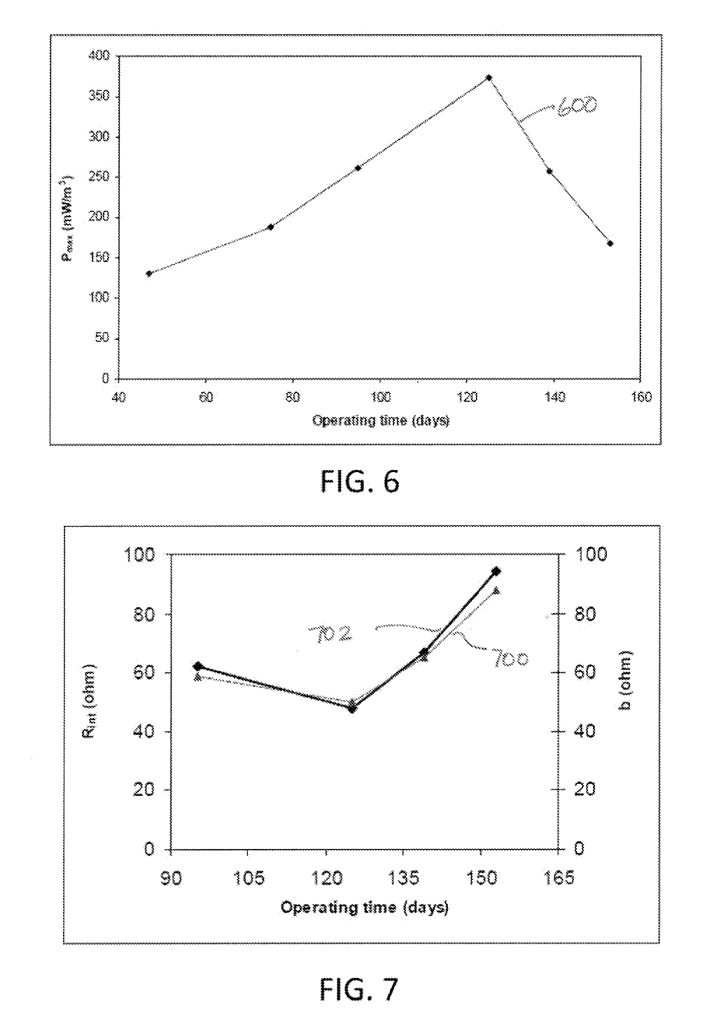

Plot 600 in FIG. 6 shows that Pₘₐₓ increased continuously from 46 days to 125 days of operation, and then decreased until the end of exposure. Similar to the observed current trend, the maximum P* increased from 260 mW/m³ at 95 days to 390 mW/m³ at 125 days at a cell voltage of around 200 mV and then decreased to 156 mW/m³ after 153 days.

The V-I curves shown in FIG. 4 can be expressed as:

V_{cell}=Vₒ−bI, (1)

where V_{cell} is the cell voltage, Vₒ is the open-circuit voltage, I is the current and b is the slope of the V-I curves. At the cell voltage Vₘₐₓ, where the maximum power output Pₘₐₓ occurs, Rᵢₙₜ=Rₑₓₜ, where Rᵢₙₜ is the internal resistance of the MFC and Rₑₓₜ is the external resistor that is placed between the anode and the cathode to obtain Vₘₐₓ (Manohar et al., Bioelectrochemistry, 72 (2008): 149-154, which is incorporated herein by reference). Rᵢₙₜ can be calculated as:

Rᵢₙₜ=V²ₘₐₓ/Pₘₐₓ. (2)

FIG. 7 shows that the slopes that were obtained from the V-I curves in FIG. 4 (plot 700) are in good agreement with Rᵢₙₜ (plot 702). Therefore, Eq. 1 becomes:

V_{cell}=Vₒ−IRᵢₙₜ. (3)

For V_{cell}=0, Eq. 3 can be expressed as:

Iₘₐₓ=Vₒ/Rᵢₙₜ, (4)

where Iₘₐₓ is the maximum current produced by the MFC. The V-I curves can be calculated as:

P=V_{cell}I=(VₒV_{cell}−V²_{cell})/Rᵢₙₜ. (5)

Pₘₐₓ can be obtained based on Eq. 2:

Pₘₐₓ=V²ₘₐₓ/Rᵢₙₜ. (6)

From dP/dV=(Vₒ−2V_{cell})/Rᵢₙₜ=0, (7)

one can obtain Vₘₐₓ=0.5Vₒ. (8)

Therefore Pₘₐₓ=V²ₒ/4Rᵢₙₜ. (9)

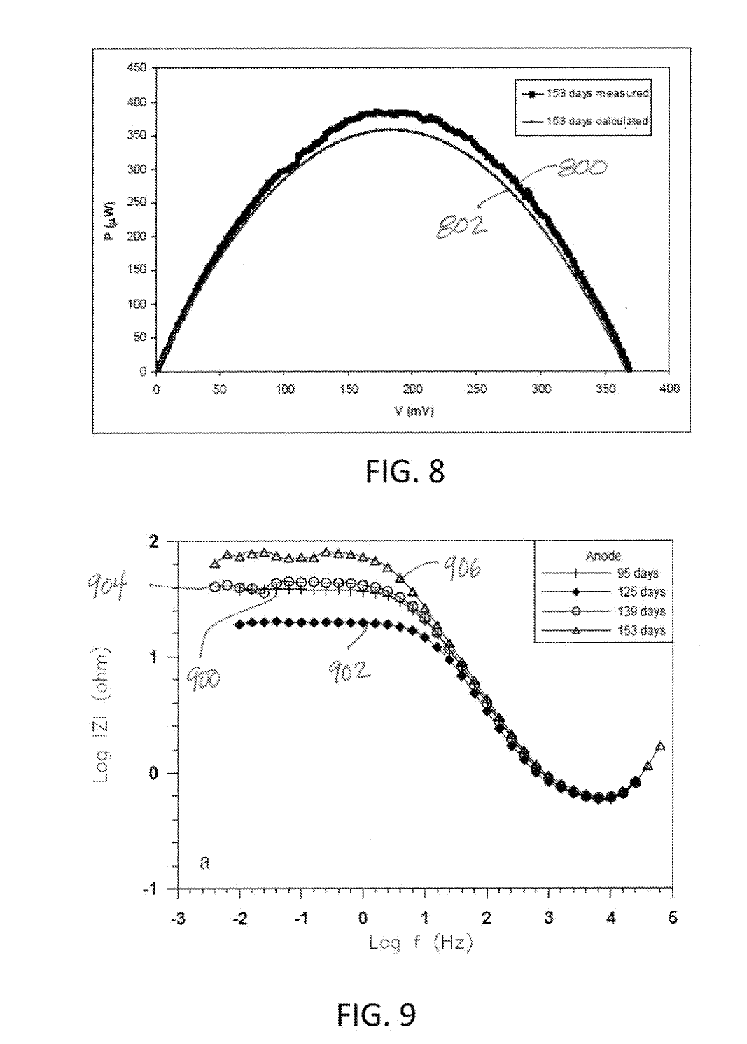

Table 1 gives a comparison of the measured and calculated Pₘₐₓ values for different operating times. Good agreement between the measured and the calculated Pₘₐₓ values was observed. Plots 800 and 802 in FIG. 8 show a comparison of measured and calculated P-V curves (Eq. 5), respectively, for an operating time of 153 days. Good agreement was observed between the measured P-V curve and the P-V curve calculated using Eq. 5. These results show that for linear V-I curves, the maximum current Iₘₐₓ produced by the MFC, the P-V curves and Pₘₐₓ can be calculated using the experimental values of Vₒ and Rᵢₙₜ.

TABLE 1
Comparison of measured and calculated maximum power output (Eq. 6).

| Operating Time | Pₘₐₓ (μW) | |
|---|---|---|
| (days) | Measured | Calculated |
| 95 | 582 | 542 |
| 125 | 829 | 744 |
| 139 | 591 | 547 |
| 153 | 384 | 358 |

The impedance spectra for the anode shown in plots 900, 902, 904, and 906 of FIG. 9 for 95 days, 125 days, 139 days, and 153 days, respectively, were analyzed using the BASICZ module of the ANALEIS software (Mansfeld et al., ASTM STP, 1188 (1993): 37-53, which is incorporated by reference herein). The equivalent circuit (EC) used contains an ohmic resistance (R_{Ω}) which is in series with the polarization resistance (Rₚ) which is in parallel with a capacitance (C). The fit parameters of the anode and cathode obtained for four different operating times are listed in Table 2 and Table 3, respectively. The capacitance (Cₐ) of the anode did not change significantly during the entire operating period. However, the polarization resistance of anode (Rₐₚ) decreased to 20Ω during the first 125 days of exposure and increased to 79Ω after 153 days (FIG. 9 and Table 2), similar to the observed variations of current and power (FIG. 4 and FIG. 5), suggesting that electricity generation by the FMFC was mainly determined by the anode performance.

TABLE 2
Fit parameters of EIS data and OCP for the anode of the FMFC.

| Operating time (days) | 95 | 125 | 139 | 153 |
|---|---|---|---|---|
| R_{Ω} (ohm) | 0.52 | 0.58 | 0.57 | 0.60 |
| Rₐₚ (ohm) | 40 | 20 | 44 | 79 |
| Cₐ (μF) | 880 | 970 | 840 | 680 |
| OCP (mV) | −46 | −54 | −36 | −15 |

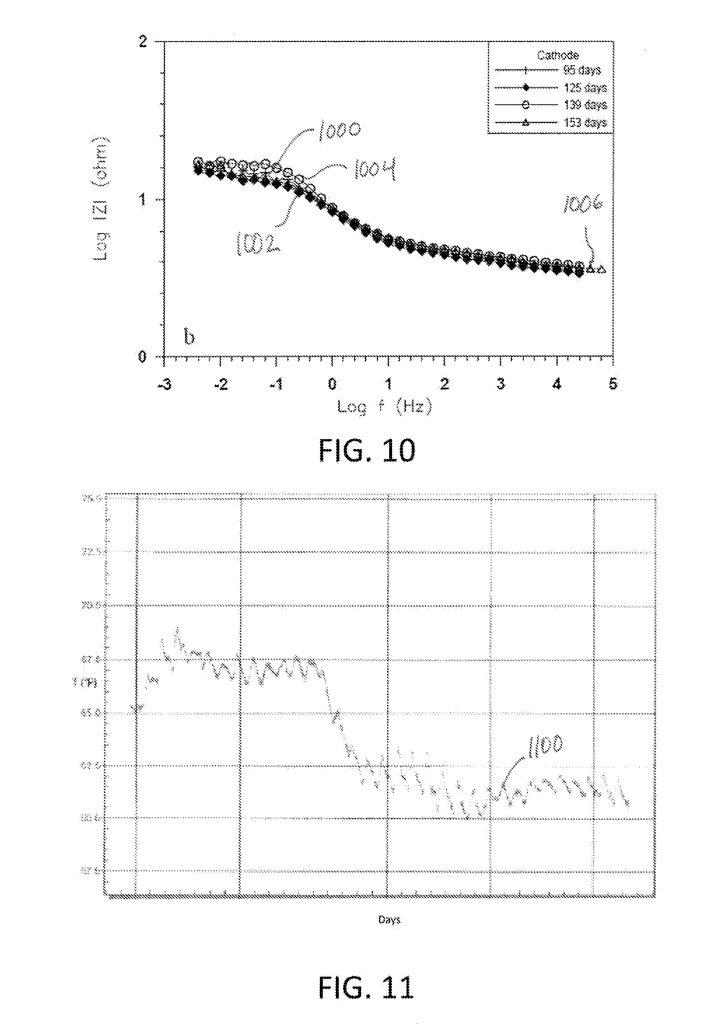

The impedance spectra for the cathode shown in plots 1000, 1002, 1004, and 1006 of FIG. 10 for 95 days, 125 days, 139 days, and 153 days, respectively, showed little change with operating time. The fit parameters of the impedance spectra and the OCPs for the cathode are shown in Table 3. The very low impedance is considered to be due to the large surface area of carbon fibers of the cathode. The OCP of the anode decreased from −46 mV at 95 days to −54 mV at 125 days and then increased to its highest value of −15 mV after 153 days, while the open-circuit potentials (OCP) of cathode remained more or less constant between 324 mV and 352 mV during the operating time.

TABLE 3
Fit parameters of EIS data and OCP for the cathode of the FMFC.

| Operating time (days) | 95 | 125 | 139 | 153 |
|---|---|---|---|---|
| R_{Ω} (ohm) | 3.38 | 3.15 | 3.48 | 3.33 |
| R_{cp} (ohm) | 15 | 16 | 21 | 17 |
| C_{c} (mF) | 200 | 650 | 390 | 420 |
| OCP (mV) | 338 | 324 | 347 | 352 |

Rᵢₙₜ has been defined as (Manohar et al., 2008):

Rᵢₙₜ=Rₐₚ+R_{cp}+R_{Ω}, (10)

where RΩ contains the ohmic losses such as the solution resistance between the anode and the cathode, the membrane resistance and the electrical resistance of the electrodes, leads, etc. The ohmic contribution to the internal resistance was very small (Tables 2 and 3). The Rᵢₙₜ values determined from Tables 2 and 3 using Eq. 10 are in very good agreement with the slopes of the V-I curves in FIG. 4 and the Rᵢₙₜ values that were calculated using Eq. 2. R_{cp} did not change significantly during the entire operating period. However, Rₐₚ changed with operating time reaching a minimum value at 125 days. These results suggest that the observed changes of Rᵢₙₜ were mainly due to the changes of Rₐₚ. Since Pₘₐₓ depends on the values of Rᵢₙₜ, it can be concluded that the observed changes of Pₘₐₓ with operating time were due to the changes of Rₐₚ. The power output could be increased by lowering Rₐₚ which could be achieved by reducing the size of the carbon granules used to increase the surface-to-volume ratio for the anode, while maintaining adequate mass transfer using the packed bed electrode principle (Manohar et al., Electrochim. Acta, 54 (2009): 1664-1670, which is incorporated herein by reference).

The digital records of the seawater temperature shown in plot 1100 of FIG. 11 were collected at the FMFC test location for the operating time of 120 days to 153 days. The temperature of the seawater decreased from 132 days to 153 days of operation. As shown in FIG. 9, Rₐₚ increased from 135 days until the end of operation (153 days). The decreased temperature could possibly reduce the anode microbial activities and therefore increase Rₐₚ. As a result, the current and the power showed a similar decrease variation from 139 days to 153 days (FIG. 4 and FIG. 5). While changes of the seawater temperature likely has an effect on the measured I and P values, it should be noted that seawater temperature may not be the only factor that affects microbial processes.

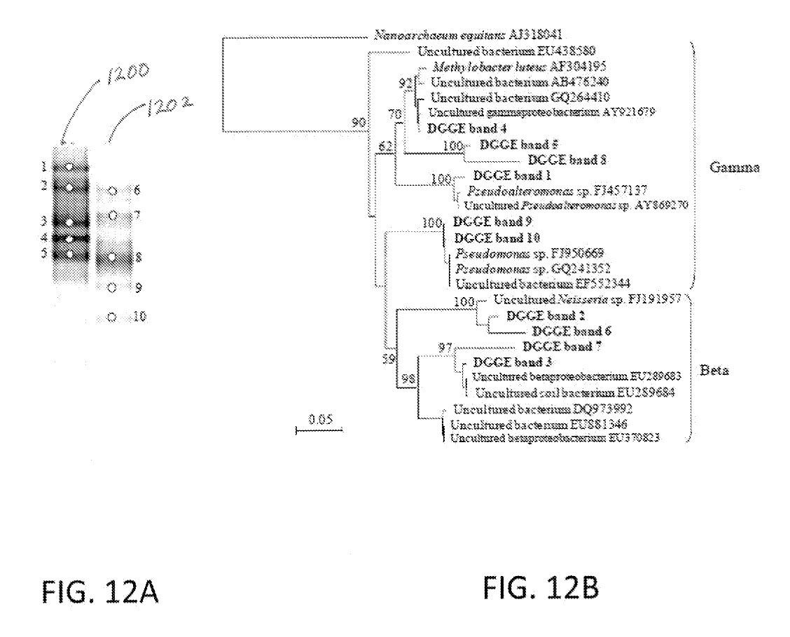

DGGE results shown in FIG. 12A indicate that bacterial populations occurring in the anode compartment (1200) were distinct compared to the bacterial populations in the inoculums (1202), suggesting that microbial population structures shifted during the FMFC operation.

Phylogenetic analysis shown in FIG. 12B demonstrated that bacterial sequences obtained from both inocula and the anode belonged to Beta and Gammaproteobacteria. Band 1 (close to Pseudoalteromonas sp.) and band 4 (gammaproteobacterium) were unique to the anode community. Gammaproteobacteria have been detected in microbial fuel cell studies. For example, Pseudoalteromonas sp. (band 1 in this report) was also found in a marine sediment microbial fuel cell fed with cysteine (Logan et al., Water Res., 39, 942-952 (2005), which is incorporated by reference herein), suggesting that this group of bacteria may play a role in terms of exoelectron transport and/or power generation. In contrast, Pseudomonas spp. (band 9 and 10) were only present in inocula, but disappeared in enriched anodic communities. Bands 6 and 7 were clustered together with bands from anode (bands 2 and 3), but phylogenetic distance indicated that they are different from the phylotypes in anode (i.e., <95% similarity). Band 5 (from anode) and band 8 (from inocula) were closely related, but identified as uncharacterized gammaproteobacteria with unknown physiological capabilities. Nevertheless, enriched mixed bacterial communities may contribute to exoelectrogenic activities occurring in the FMFC.

In summary, electricity was produced from the FMFC over the 153 days of operation. The power gradually increased for the first 125 days and then decreased. The V-I curves obtained using a potentiodynamic scan at four different operating periods showed a linear relationship between V and I. For linear V-I curves Iₘₐₓ produced by the MFC, the P-V curves and Pₘₐₓ can be calculated based on the experimental values of Vₒ and Rᵢₙₜ.

The polarization resistance of the cathode (R_{cp}) did not show significant changes during the entire operating time, while the polarization resistance of the anode (Rₐₚ) decreased for the first 125 days and then increased until the end of operation. The ohmic contribution to Rᵢₙₜ was small. The stable and low R_{cp} values suggest that the observed changes of Rᵢₙₜ were mainly due to the changes of Rₐₚ. These results suggest that the observed changes in power generation during the operating time are due to the changes of Rₐₚ, which exhibited a similar trend as the variations of the cell current and power concentration.

The continuous electricity production during the long-term operation (more than 120 days) suggests that the FMFC was able to utilize organic compounds and nutrients from seawater for energy production. The cell current decrease observed at the end of exposure may be due at least in part to the decrease of the ocean temperature.

Molecular analyses (PCR-DGGE) revealed that distinct bacterial groups were developed and enriched in the anode compartment of the FMFC, suggesting these groups played roles in power generation and/or carbon source utilization.

A number of embodiments have been described. Nevertheless, it will be understood that various modifications may be made without departing from the spirit and scope of the disclosure. Accordingly, other embodiments are within the scope of the following claims.

What is claimed is:

1. A microbial fuel cell comprising:
a cation exchange membrane defining an anode chamber;
an anode positioned in the anode chamber;
a cathode in contact with an exterior of the cation exchange membrane; and
a restrictor in contact with the cation exchange membrane and defining an opening through which water flows into or out of the anode chamber

2. The microbial fuel cell of claim 1, wherein the microbial fuel cell is cylindrical in shape.

3. The microbial fuel cell of claim 1, wherein the cation exchange membrane is tubular.

4. The microbial fuel cell of claim 1, wherein the anode chamber defines a volume of at least 1 L.

5. The microbial fuel cell of claim 1, wherein the anode comprises carbon.

6. The microbial fuel cell of claim 5, wherein the carbon comprises granular carbon.

7. The microbial fuel cell of claim 6, wherein a size of the granular carbon is in a range between 3 mm and 10 mm.

8. The microbial fuel cell of claim 1, wherein the anode comprises a conductive current collector.

9. The microbial fuel cell of claim 1, wherein the cathode comprises a conductive material and a catalyst to facilitate reduction of oxygen at the cathode.

10. The microbial fuel cell of claim 9, wherein the conductive material and the catalyst are supported by an exterior surface of the cation exchange membrane, and an interior surface of the cation exchange membrane defines the anode chamber.

11. The microbial fuel cell of claim 10, wherein the catalyst is supported by the exterior surface of the cation exchange membrane, and the conductive material forms a layer on the catalyst.

12. The microbial fuel cell of claim 11, further comprising additional catalyst forming a layer on the conductive material.

13. The microbial fuel cell of claim 9, wherein the conductive material comprises carbon fibers.

14. The microbial fuel cell of claim 13, wherein the conductive material comprises a metal coating supported by the carbon fibers.

15. The microbial fuel cell of claim 9, wherein the catalyst comprises platinum.

16. The microbial fuel cell of claim 1, further comprising a second restrictor in contact with the cation exchange membrane, the second restrictor defining a second opening through which water flows into or out of the anode chamber.

17. The microbial fuel cell of claim 1, wherein the microbial fuel cell is operable to generate electricity in the absence of an external power source.

18. The microbial fuel cell of claim 1, wherein the anode chamber comprises bacteria for oxidizing organic compounds.

19. The microbial fuel cell of claim 1, wherein the microbial fuel cell has an associated buoyancy that causes the microbial fuel cell to float.

20. An apparatus comprising:
a buoy; and
a microbial fuel cell coupled to the buoy, the microbial fuel cell comprising:
a cation exchange membrane defining an anode chamber;
an anode positioned in the anode chamber;
a cathode in contact with an exterior of the cation exchange membrane; and
a restrictor in contact with the cation exchange membrane and defining an opening through which water flows into or out of the anode chamber.

21. The apparatus of claim 20, wherein the buoy comprises an electrically powered device, the microbial fuel cell is electrically coupled to the electrically powered device, and the microbial fuel provides electricity to the electrically powered device.

22. A method comprising:
positioning a buoy comprising an electrically powered device and a microbial fuel cell in a body of water; and
powering the electrically powered device with electricity generated by the microbial fuel cell.
